(19) United States
(12) Patent Application Publication
(10) Pub. No.: US 2016/0284023 A1
(43) Pub. Date: Sep. 29, 2016

(54) PREDICTIVE FINANCIAL MANAGEMENT SYSTEM

(71) Applicant: INTERNATIONAL BUSINESS MACHINES CORPORATION, Armonk, NY (US)

(72) Inventors: Francesca Curzi, Rome (IT); Raffaella Viola, Rome (IT)

(21) Appl. No.: 14/670,518

(22) Filed: Mar. 27, 2015

(51) Int. Cl. G06Q 40/06; G06N 5/02

(52) U.S. Cl. CPC G06Q 40/06; G06N 5/02

(57) ABSTRACT

Embodiments of the present invention provide methods and systems for predicting expenses. The method may include receiving a set of input parameters based on financial objectives of a user and updating financial data in a central repository. A saving trend graph depicting projected savings trend lines is created and the projected saving trend lines may be selected based on the preferences of a user.

### BACKGROUND OF THE INVENTION

The present invention relates generally to a financial management system, and more particularly to an intelligent financial management system to address and maintain a controlled economic situation based on both actual and planned incomes and expenses.

It is useful to have an expense storing method to help maintain economic stability according to certain requested savings standards. Financial management systems can help control both savings and expenses and can be adjusted for both personal and commercial use. Specifically, an ideal financial management system can help avoid overdrawing checking accounts and respect savings thresholds, provide a projection with a predictive analysis of an economic situation based on incomes and fixed and unfixed costs, and help plan future expenses based on available resources.

### SUMMARY

A method for predicting expenses, the method comprising: receiving, by one or more computer processors, a plurality of input parameters, wherein the input parameters are based on financial objectives of a user; triggering, by one or more systems of records and one or more systems of engagement, an update of financial data in a central repository; optimizing the financial data for one or more plugins; generating, by one or more computer processors, options for reducing one or more expenses and increasing one or more savings; creating, by one or more computer processors, a saving trend graph, wherein the saving trend graph displays one or more projected saving trend lines; selecting, by one or more computer processors, one or more projected saving trend lines based on the input parameters; and storing, by one or more computer processors, the one or more selected projected saving trend line in the central repository.

### BRIEF DESCRIPTION OF THE DRAWINGS

FIG. 1 is a functional block diagram illustrating a financial management system, in accordance with an embodiment of the present invention;

FIG. 2 is a flowchart depicting operational steps of a financial management system showing the projection process, in accordance with an embodiment of the present invention;

FIG. 3 is a flowchart depicting operational steps of a financial management system showing an optimization plugin, in accordance with an embodiment of the present invention;

FIG. 4 shows a graph depicting the output of the projection process of a financial management system, in accordance with an embodiment of the present invention; and

FIG. 5 is a block diagram of internal and external components of a computer system, in accordance with an embodiment of the present invention.

### DETAILED DESCRIPTION

Existing financial management systems focus on automated systems to manage income and expenses. The proposed financial management system is an intelligent expense control, forecast, and planning system. This intelligent solution uses data from multiple sources, processes this data, and then presents the processed data for personal or commercial use. Specific information collection settings provide a predictive analysis so that the user can identify actual and/or potential economic issues and find a solution to remedy those issues. Embodiments of the present invention provide systems, methods, and computer program products for predicting and managing finances using both actual and planned incomes and expenses.

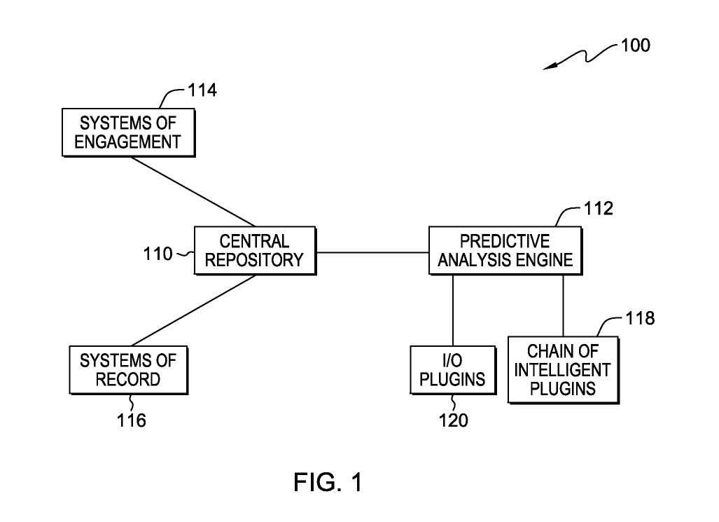

The present invention will now be described in detail with reference to the figures. FIG. 1 is a functional block diagram illustrating a financial management system, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. In an exemplary embodiment, financial management system 100 includes central repository 110, predictive analysis engine 112, systems of engagement 114, systems of record 116, and chain of intelligent plugins 118.

Central repository 110 collects the data necessary to determine financial variables, which are eventually provided to the end user via output graph 400. The financial variables tracked by central repository 110 are expenses, incomes (both planned and unplanned), saving objectives, fixed thresholds, and other fixed and unfixed variables relevant to financial management. This information presents details regarding expenses and helps in the creation of a predictive financial analysis. Central repository 110 can be implemented using any storage media in the art.

Predictive analysis engine 112 is a processor that accesses and presents the data stored by central repository 110. Predictive analysis engine 112 queries chain of intelligent plugins 118 to calculate a best path to achieve objective O and target date T. In this exemplary embodiment, objective O is an input parameter that represents a budget target or savings goal. For example, objective O can represent the point at which a loan is completely paid off or the point at which enough money has been saved to take a vacation, or both. In this exemplary embodiment, target date T is an input parameter that signifies the date that a certain objective O is achieved.

Predictive analysis engine 112 performs three types of calculations, according to the parameters needed by the user: different paths, saving trend graph with risk factors, and best path. First, based on input parameter objective O, predictive analysis engine 112 queries chain of intelligent plugins 118 to calculate different paths, i.e., saving trend, to achieve objective O. Different target dates, i.e., T1, T2, and T3, will be calculated and shown. Second, based on input parameter objective O, predictive analysis engine 112 queries chain of intelligent plugins 118 to calculate different saving trend graphs and risk factors related to the removal/addition of certain priority level expense plugins. Together, these two calculations are known as the “what if” analysis. Third, based on input parameters objective O and target date T, predictive analysis engine 112 queries chain of intelligent plugins 118 to calculate the best path, or solution, to achieve the respective objective O by target date T. This calculation is referred to as the “optimization function.” Predictive analysis engine 112 corrects the proposed solutions based on the data provided by the intelligent income plugins and expense plugins of chain of intelligent plugins 118. Predictive analysis engine 112 then prepares the corrected proposals and warning information for the user and outputs the calculations (i.e., saving trend graph, risk factor, alerts/warnings). It should be appreciated that in one embodiment, a parser is used to extract data and update central repository 110.

Chain of intelligent plugins 118 comprises one or more intelligent plugins that are used for providing a market analysis and advertising for expense optimization. Input/output (I/O) plugins 120 are used for end user input and output and implement the user interface of the system. In this exemplary embodiment, intelligent plugins are broken down into income plugins and expense plugins. These plugins are active and have the implemented intelligence that, based on information available in the network, dynamically verify possible actions that could increase efficiency.

Each intelligent plugin accesses and processes data available in systems of record 116 to identify best options that can be provided to the user to optimize income and expenses. In this exemplary embodiment, predictive analysis engine 112 queries the plugins of chain of intelligent plugins 118 to verify when a certain objective O can be accomplished based on different optimizations and which optimizations will achieve a certain target date T. For example, a “gas” plugin analyzes information and advertising from different brokers and directly consults the network, proposing a possible improvement that can help in saving resources and costs. Generally, the network can be, for example, a local area network (LAN), a wide area network (WAN) such as the Internet, or a combination of the two, and include wired, wireless, or fiber optic connections. Each plugin can calculate the savings associated with reducing the plugin's expense to zero, and considering the priority of what expense/income it handles, e.g., priority levels 1-5, calculate the risk factor (e.g., priority levels 1-5 where priority level 1 indicates the lowest risk and priority level 5 indicates the highest risk).

Systems of engagement 114 and systems of record 116 are components that store and extract information from a network. In this exemplary embodiment, systems of engagement 114 and systems of record 116 advise predictive analysis engine 112 to update central repository 110 with data from the network. Trigger information is stored in systems of engagement 114 and systems of record 116 and determines when to alert predictive analysis engine 112 to update central repository 110. For example, when the user's checking account incurs a charge, systems of record 116 triggers predictive analysis engine 112 to update central repository 110 data to reflect the charge.

Systems of record 116 comprises one or more systems of record and are information storage systems that are the authoritative data source for a given data element or piece of information. Systems of record 116 take output data from multiple source systems, re-process the data, and then re-present the result for a new business use, i.e., saving trend prediction analysis. Systems of record 116 log transactions and keep financial accounting in order. Systems of engagement 114 is a new concept that differs from systems of record 116 in that it dynamically focuses on people, not processes. Systems of engagement 114 can be used instead of, or together with, systems of record 116.

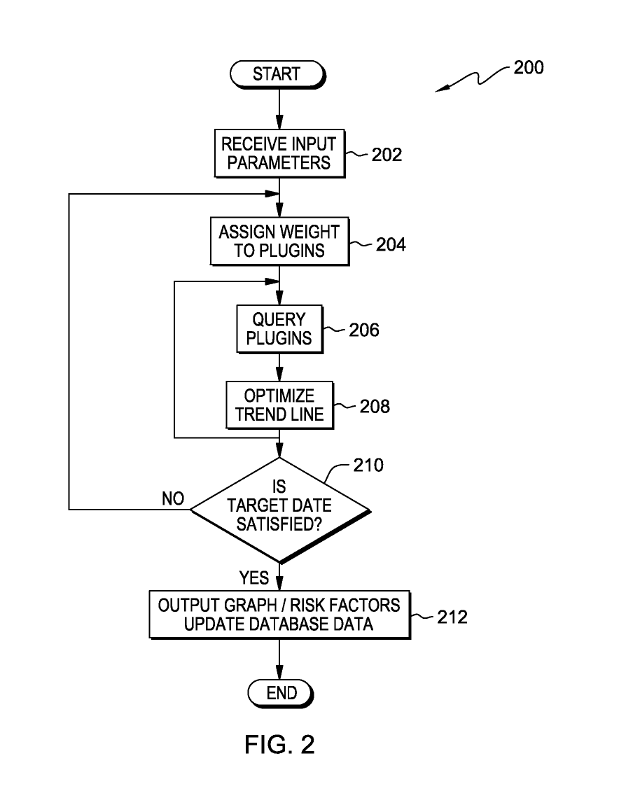

FIG. 2 is a flowchart 200 depicting operational steps of a financial management system showing the projection process, in accordance with an embodiment of the present invention. In this exemplary embodiment, predictive analysis engine 112 queries chain of intelligent plugins 118 to calculate the best path to achieve objective O by target date T. Each plugin of chain of intelligent plugins 118 is assigned a weight based on its priority in everyday life. Savings can be calculated for reducing the expenses of each plugin, which are applied to the saving trend line. The process can be reiterated to improve the saving trend.

In step 202, predictive analysis engine 112 receives input parameters objective O and target date T based on the user's preferences.

In step 204, predictive analysis engine 112 assigns a weight to each plugin within chain of intelligent plugins 118. In this exemplary embodiment, each plugin processes data accessed from systems of record 116 or systems of engagement 114 (in general, the network) to identify the best options that can be provided to the user to optimize income and expenses. Each plugin can calculate the savings of progressively reducing the expense to zero, considering the priority (i.e., priority levels 1-5) of what income or expense it handles. The plugins analyze information and advertising from different brokers by directly consulting the network and propose a possible improvement that can help in saving resources and costs. For example, in one embodiment, chain of intelligent plugins 118 includes income plugins salary, rent, and eBay and expense plugins gas (i.e., oil-based for transportation), energy (i.e., natural gas and electricity), food, home (i.e., mortgage or rent), and satellite television. In this embodiment, the eBay income plugin represents income made from selling personal items, i.e., furniture, on eBay or through any other online/offline marketplace. However, expense plugins such as satellite television can be reduced to zero, i.e., removed, because they are a luxury and not essential to life. However, expenses like gas and energy cannot be removed but can only be reduced because they are necessities. Similarly, food and home expenses are essential and can only be reasonably reduced. Therefore, in this example, income plugins salary, rent, and eBay could be given priority levels of 5, 5, and 1, respectively. Expense plugins gas, energy, food, home, and satellite television could be given priority levels of 4, 4, 5, 5, and 0, respectively. It should be appreciated that plugin priority levels will vary depending on the user.

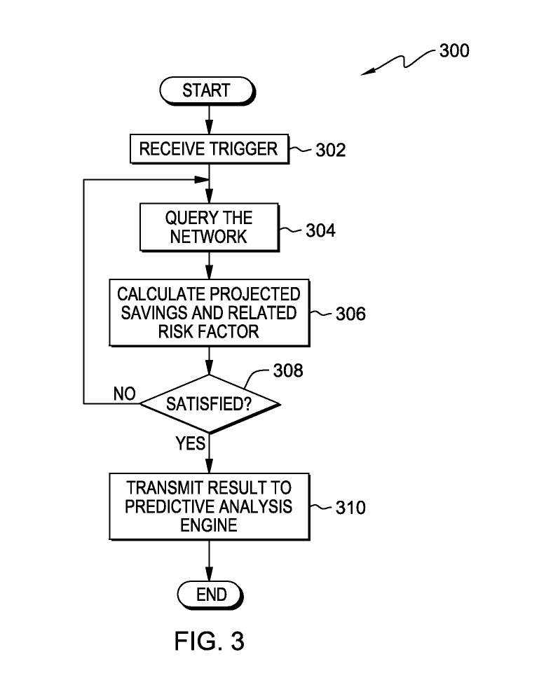

For illustrative purposes, the following discussion is made with respect to one plugin in chain of intelligent plugins 118, it being understood that steps 206 and 208 can be repeated for each intelligent plugin. In step 206, predictive analysis engine 112 queries chain of intelligent plugins 118 in order to verify when objective O can be accomplished based on different optimizations and which optimizations can be carried out in order to achieve objective O on a certain target date T. This occurs using the optimization process of FIG. 3, as explained in greater detail below. In this exemplary embodiment, predictive analysis engine 112 first determines if and when objective O can be reached. This is referred to as “direct” analysis. Then, starting from objective O, predictive analysis engine 112 identifies which actions can be optimized in order to achieve it. This is referred to as “bottom up” analysis. For example, predictive analysis engine 112 will determine if the user will be able to pay for a new car (objective O) within one year (target date T). Then, predictive analysis engine 112 identifies the different ways to completely pay off the new car within one year (i.e., removing satellite television expenses, reducing gas expenses, etc.).

In step 208, predictive analysis engine 112 optimizes the saving trend line. The saving trend line illustrates the path of savings over time. This data is from the individual plugin data calculated in FIG. 3 and will be discussed in greater detail below. In this exemplary embodiment, the saving trend line can be optimized by altering expenses. For example, objective O can be reached sooner, i.e., in less time, by removing priority 0 expenses. Moreover, objective O can be accomplished even quicker by altering priority 5 expenses. This is typically done by reasonably reducing spending on certain priority 5 expenses and/or reducing priority level. The saving trend line is illustrated in FIG. 3 and will be discussed in greater detail below.

In step 210, predictive analysis engine 112 determines whether target date T has been satisfied. In this exemplary embodiment, predictive analysis engine 112 queries central repository 110 to confirm that objective O has been met by target date T before outputting data. In another embodiment, central repository 110 can transmit information to predictive analysis engine 112. In yet another embodiment, predictive analysis engine 112 can receive information from one or more components of financial management system 100.

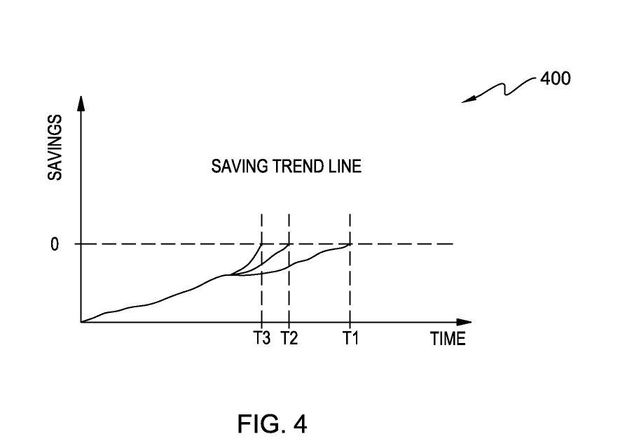

If, in step 210, predictive analysis engine 112 determines that target date T has been satisfied, then in step 212, predictive analysis engine 112 presents output graph 400 and risk factors to the user and will update central repository 110 accordingly. In this exemplary embodiment, output graph 400 displays the saving trend line in relation to objective O and target date T. The risk factors are related to the removal and/or addition of plugin expenses. An example of output graph 400 is shown in FIG. 4 and will be discussed in greater detail below. Predictive analysis engine 112 then updates central repository 110 is updated with the new trend line data and risk factor data.

If, in step 210, predictive analysis engine 112 determines that target date T has not been satisfied, then predictive analysis engine 112 restarts the projection process from step 204.

FIG. 3 is a flowchart 300 depicting operational steps of a financial management system showing the optimization of a plugin of chain of intelligent plugins 118 as it is updated, in accordance with an embodiment of the present invention. In this exemplary embodiment, each intelligent plugin can be configured to have a saving trigger that notifies the intelligent plugin to update data and start the plugin update process. Each intelligent plugin analyzes data from systems of engagement 114 and systems of record 116. For example, income plugin salary is triggered and updated upon direct deposit of a paycheck in the user's checking account.

In step 302, a plugin in chain of intelligent plugins 118 receives a trigger to begin the data optimization process. In this exemplary embodiment, the trigger can be a request for a “what if” or “optimization” analysis.

I/O plugins 120, however, are triggered in two phases: at system initialization, i.e., booting up, and on demand. In the initialization phase, thresholds are established for the alert messages. These alert messages advise the user of the close proximity to the thresholds or if the user has exceeded the thresholds. At the on demand phase, systems of engagement 114 and systems of record 116 advise predictive analysis engine 112 to update data in central repository 110 based on fixed and cyclic information. For example, the on demand data update process is triggered by expense events such as a direct update from an interface (i.e., manual input by user), a money transfer, credit card activity (i.e., monthly bill), and debit card charge. The on demand data update process is also triggered by income events such as direct deposit, money transfer, credit card refund, etc. Moreover, the on demand data update process can be started manually by the user requesting an optimization or a “what if” analysis.

In step 304, chain of intelligent plugins 118 queries the network for optimization based on the trigger. In this exemplary embodiment, each plugin in chain of intelligent plugins 118 that has been triggered queries the network for updated data, through systems of engagement 114 and systems of record 116.

In step 306, chain of intelligent plugins 118 calculates the projected savings or increased expenses and a related risk factor. In this exemplary embodiment, each projected savings or projected increase in expenses is given a risk factor. As previously discussed, the risk factor is associated with the priority of the expense or income. For example, increasing spending for a low priority expense (i.e., priority 1 or 2) will yield a high risk factor.

In step 308, chain of intelligent plugins 118 determines whether the projection satisfies objective O and target date T, and whether the associated risk factor is satisfactory to the user. In this exemplary embodiment, each plugin must confirm that objective O has been met by target date T and that the risk factor associated with the projection is acceptable to the user.

If, in step 308, chain of intelligent plugins 118 determines that objective O and target date T have been satisfied, then in step 310, chain of intelligent plugins 118 outputs the projection and risk factor to predictive analysis engine 112. Predictive analysis engine 112 uses the projections and corresponding risk factors for the saving trend output graph 400. The projections and risk factors are also saved in central repository 110.

If, in step 308, chain of intelligent plugins 118 determines that objective O or target date T have not been satisfied, or that the associated risk factor is not acceptable to the user, then chain of intelligent plugins 118 restarts the optimization process from step 304.

FIG. 4 shows output graph 400 of the projection process discussed in flowchart 200 above, in accordance with an embodiment of the present invention. Output graph 400 displays the saving trend line with respect to savings vs. time. As shown, objective O represents a certain level of savings or target budget to be achieved. Target date T is the date at which objective O is achieved. FIG. 4 shows three different target dates T1, T2, and T3 which represent the target dates at which expenses remain unchanged, priority 0 expenses are removed, and priority 5 expenses are reduced, respectively. As previously discussed, if the expenses for satellite television are removed, objective O will be obtained at an earlier target date T, i.e., change from T1 to T2. Moreover, if the expenses for food and home are reduced, objective O will be obtained at an even earlier target date T, i.e., change from T2 to T3.

As previously discussed, there are risk factors associated with each plugin. For example, if a given solution proposes to remove satellite television expenses, the risk factor will be low because the priority associated to this expense, i.e., priority 0, is not high. However, if a given solution proposes to remove more important expenses, i.e., private tutoring for a child or a gym membership, the risk factor will be higher because these expenses carry a higher priority. Therefore, the risk factor of a solution is directly related to the priority level of the plugins to be altered.

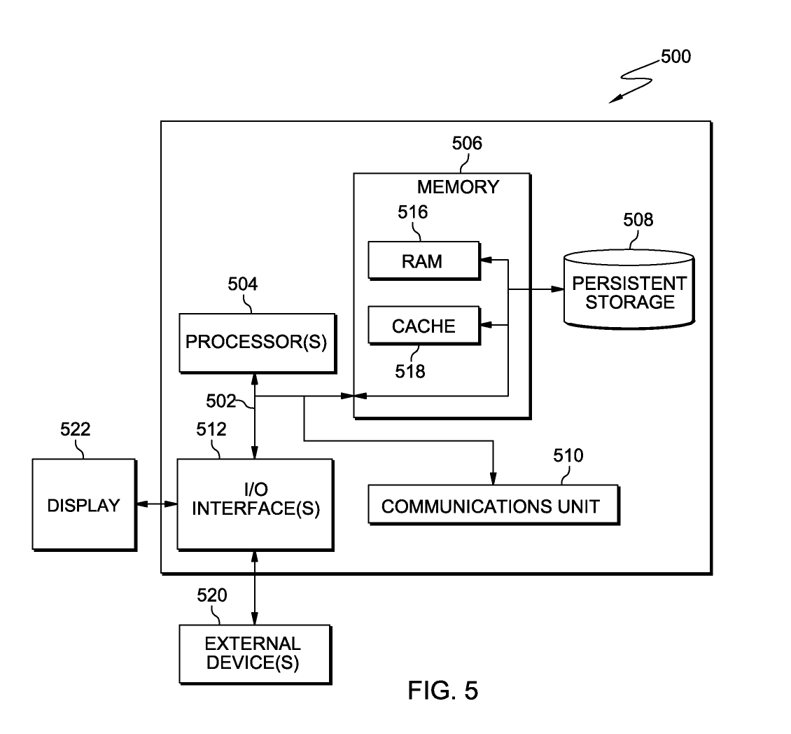

FIG. 5 is a block diagram of internal and external components of a computer system 500, which is representative the computer systems of FIG. 1, in accordance with an embodiment of the present invention. It should be appreciated that FIG. 5 provides only an illustration of one implementation and does not imply any limitations with regard to the environments in which different embodiments may be implemented. In general, the components illustrated in FIG. 5 are representative of any electronic device capable of executing machine-readable program instructions. Examples of computer systems, environments, and/or configurations that may be represented by the components illustrated in FIG. 5 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 500 includes communications fabric 502, which provides for communications between one or more processors 504, memory 506, persistent storage 508, communications unit 510, and one or more input/output (I/O) interfaces 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 516 and cache memory 518. In general, memory 506 can include any suitable volatile or non-volatile computer-readable storage media. Software (i.e., financial management system 100) is stored in persistent storage 508 for execution and/or access by one or more of the respective processors 504 via one or more memories of memory 506.

Persistent storage 508 may include, for example, a plurality of magnetic hard disk drives. Alternatively, or in addition to magnetic hard disk drives, persistent storage 508 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 508 can also be removable. For example, a removable hard drive can be used for persistent storage 508. Other examples include optical and magnetic disks, thumb drives, and smart cards that are inserted into a drive for transfer onto another computer-readable storage medium that is also part of persistent storage 508.

Communications unit 510 provides for communications with other computer systems or devices via a network (e.g., financial management system 100). In this exemplary embodiment, communications unit 510 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to a computer system through communications unit 510 (e.g., via the Internet, a local area network or other wide area network). From communications unit 510, the software and data can be loaded onto persistent storage 508.

One or more I/O interfaces 512 allow for input and output of data with other devices that may be connected to computer system 500. For example, I/O interface 512 can provide a connection to one or more external devices 520 such as a keyboard, computer mouse, touch screen, virtual keyboard, touch pad, pointing device, or other human interface devices. External devices 520 can also include portable computer-readable storage media such as, for example, thumb drives, portable optical or magnetic disks, and memory cards. I/O interface 512 also connects to display 522.

Display 522 provides a mechanism to display data to a user and can be, for example, a computer monitor. Display 522 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1-7. (canceled)

8. A computer program product comprising:
a computer readable storage medium and program instructions stored on the computer readable storage medium, the program instructions comprising:
program instructions to receive a plurality of input parameters, wherein said input parameters are based on financial objectives of a user;
program instructions to trigger, by one or more systems of records and one or more systems of engagement, an update of financial data in a central repository;
program instructions to optimize said financial data for each of said one or more plugins;
program instructions to generate options for reducing one or more expenses and increasing one or more savings;
program instructions to create a saving trend graph, wherein said saving trend graph displays one or more projected saving trend lines;
program instructions to select one or more projected saving trend lines based on said input parameters; and
program instructions to store said one or more selected projected saving trend line in said central repository.

9. The computer program product of claim 8, wherein each of said one or more plugins gathers data associated with an income or an expense of said user.

10. The computer program product of claim 8, wherein said plugins are assigned a weight, wherein said weight is a relative value based, at least in part, on a priority associated with the plurality of input parameters.

11. The computer program product of claim 8, wherein said one or more projected saving trend lines predict a time at which a savings objective can be reached.

12. The computer program product of claim 8, wherein said systems of record and said systems of engagement are data management systems that trigger an engine to process and store data from a network.

13. The computer program product of claim 8, wherein optimizing the financial data for each of said one or more plugins comprises:
inquiring, by one or more computer processors, a network for updated data;
updating, by one or more computer processors, data in the central repository;
optimizing, by one or more computer processors, the data in the central repository;
calculating, by one or more computer processors, projected savings and related risk factors; and
sending, by one or more computer processors, said projected savings and said related risk factors to an engine.

14. The computer program product of claim 13, wherein said risk factors are related to a change in incomes and expenses.

15. A computer system comprising:
one or more computer processors;
one or more computer readable storage media;
program instructions stored on the computer readable storage media for execution by at least one of the one or more processors, the program instructions comprising:
program instructions to receive a plurality of input parameters, wherein said input parameters are based on financial objectives of a user;
program instructions to trigger, by one or more systems of records and one or more systems of engagement, an update of financial data in a central repository;
program instructions to optimize said financial data for each of said one or more plugins;
program instructions to generate options for reducing one or more expenses and increasing one or more savings;
program instructions to create a saving trend graph, wherein said saving trend graph displays one or more projected saving trend lines;
program instructions to select one or more projected saving trend lines based on said input parameters; and
program instructions to store said one or more selected projected saving trend line in said central repository.

16. The computer system of claim 15, wherein each of said one or more plugins gathers data associated with an income or an expense of said user.

17. The computer system of claim 15, wherein said plugins are assigned a weight, wherein said weight is a relative value based, at least in part, on a priority associated with the plurality of input parameters.

18. The computer system of claim 15, wherein said one or more projected saving trend lines predict a time at which a savings objective can be reached.

19. The computer system of claim 15, wherein said systems of record and said systems of engagement are data management systems that trigger an engine to process and store data from a network.

20. The computer system of claim 15, wherein optimizing the financial data for each of said one or more plugins comprises:
inquiring, by one or more computer processors, a network for updated data;
updating, by one or more computer processors, data in the central repository;
optimizing, by one or more computer processors, the data in the central repository;
calculating, by one or more computer processors, projected savings and related risk factors; and
sending, by one or more computer processors, said projected savings and said related risk factors to an engine.
